(19) United States
(12) Patent Application Publication
(10) Pub. No.: US 2007/0251353 A1
(43) Pub. Date: Nov. 1, 2007

(54) TOOTH STRAIGHTENING MACHINE FOR BAND SAW BLADES

(76) Inventor: Walter OPPLIGER, Uetendorf (CH)

Correspondence Address: LADAS & PARRY LLP, 224 SOUTH MICHIGAN AVENUE, SUITE 1600, CHICAGO, IL, 60604, US

(21) Appl. No.: 11/688,919

(22) Filed: Mar. 21, 2007

(30) Foreign Application Priority Data
Mar. 21, 2006 (CH) 2006 00433/06

(51) Int. Cl. B23D 63/00

(52) U.S. Cl. 76/50.2

(57) ABSTRACT

Device for straightening the teeth of a band saw blade (1) with a measuring device (4) for measuring the bending of the individual teeth relative to the tooth root and setting pliers (5) arranged at a distance behind the measuring device in the travel direction of the saw blade to form the tooth back into the plane of the saw blade.

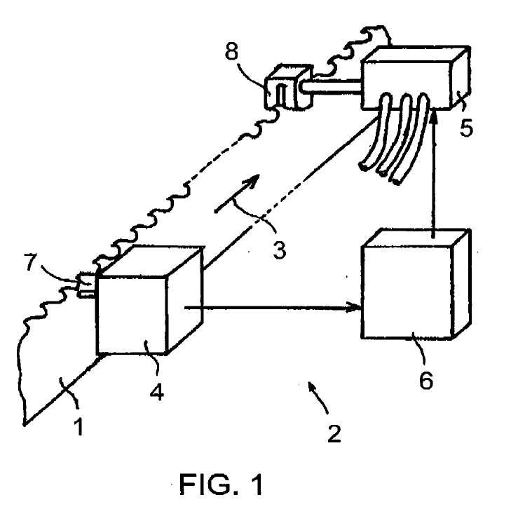

The invention relates to a device for straightening the teeth of a band saw blade.

Band saw blades that operate at high cutting rates, in particular when cutting round wood, can be subjected to high lateral pressure peaks that not only cause unevenness of the saw blade, but also frequently result in a bending of individual teeth. Bent teeth lead on the one hand to unclean cuts and on the other hand to a further load on the saw blade. For this reason the teeth have to be straightened at regular intervals before they can be sharpened. Until now the bent teeth had to be straightened using a setting key. As well as requiring practical experience, this also takes a considerable amount of time.

The object of the invention is to create a possibility for straightening the teeth of a band saw blade fully automatically.

This object is achieved according to the invention by means of a measuring device for measuring the bending of individual teeth in relation to the tooth root and setting pliers arranged at a distance behind the measuring device in the travel direction of the saw blade to pull back a bent tooth into the plane of the saw blade.

A preferred embodiment of the invention is described below with reference to the attached drawing. The drawing shows a perspective view of a tooth straightening device according to the invention.

A band saw blade 1 is guided upright, i.e. with the teeth pointing upwards. The present tooth straightening device can naturally also be employed in the case of a horizontal saw blade. A tooth straightening station 2 is arranged on a straight section of the saw blade. The blade runs in the direction indica-ed by an arrow 3. If the tooth straightening station 2 is, for example, part of a sharpening machine, it is preferably arranged on the opposite straight leg of the saw blade run to the sharpening station. The tooth straightening device can, however, also be an independent machine.

The tooth straightening station 2 essentially has a measuring device 4 for measuring the bending of the individual teeth, setting pliers 5 for bending back the teeth into the plane of the saw blade 1 and a control device 6 for receiving a measuring signal from the measuring device and for transmitting a straightening signal to the setting pliers. In addition the controller serves to advance each measured tooth by the distance between the measuring device and the setting pliers. Alternatively the controller can temporarily store the measuring or straightening signals for each measured tooth and at the setting pliers allocate the corresponding straightening signal to the particular tooth.

In the measuring device 4, the stepwise advanced saw blade is clamped by suitable holding means (not shown) for the duration of the measurement. The measuring device has a stylus 7 as a sensor that traces each tooth near its highest point. The sensor is set to zero each time it reaches the tooth root. In the event of a bending of the tooth, the sensor outputs a signal on the extent of the deviation to the controller 6. In the controller the measuring signal is transformed into straightening information that is passed on to the setting pliers 5.

The setting pliers 5 are located at a distance from the measuring device corresponding to an appropriate number of tooth gaps that in the present embodiment lies between 15 and 20 teeth. The setting pliers have jaws 8 arranged on both sides of the saw blade to exercise a lateral pressure on the tooth in the pliers while the blade is counter-held near the tooth root by a guide (not shown). The level of the pressure exerted depends on the degree of bending and is controlled by the straightening signal.

The jaws 8 of the setting pliers are actuated pneumatically. Of course, another form of actuation, for example hydraulic, is also suitable.

1. Device for straightening the teeth of a band saw blade comprising: a measuring device for measuring the bending of the individual teeth relative to the tooth root and setting pliers arranged at a distance behind the measuring device in the travel direction of the saw blade to form the tooth back into the plane of the saw blade.

2. Device according to claim 1, wherein the setting pliers are equipped with jaws to exert a lateral pressure on an individual tooth.

3. Device according to claim 1, further comprising: a control device for receiving a measuring signal and transforming the measuring signal into a straightening signal.
